(19) United States
(12) Patent Application Publication
(10) Pub. No.: US 2019/0121915 A1
(43) Pub. Date: Apr. 25, 2019

(54) SHARING SEARCH CRITERIA ACROSS MULTIPLE SEARCH SPACES

(71) Applicant: Amadeus S.A.S., Biot (FR)

(72) Inventors: Matthieu Torrenti, Sophia Antipolis (FR); Gael Fontaine, Antibes (FR); Amar Kadamalakunte, Antibes (FR)

(21) Appl. No.: 15/788,408

(22) Filed: Oct. 19, 2017

(51) Int. Cl. G06F 17/30; H04L 29/06

(52) U.S. Cl. CPC G06F 17/30893; G06Q 50/14; H04L 63/102; G06F 17/30867

(57) ABSTRACT

Methods, systems, and computer program products for processing search criteria across multiple search spaces. The system includes one or more processors and a memory coupled to the processors. The memory stores data comprising program code that, when executed by the processors, causes the system to receive authentication information to grant a user access to a universal profile platform associated with the system. In response to receiving the authentication information, the system is caused to grant access to the universal profile platform. The universal profile platform provides access to a first search website and a second search website that are external to the system. The system is further caused to store, in a universal profile database, profile data that includes a plurality of search criteria submitted by the user to the first search website. The search criteria indicates at least one parameter of a search performed by the first search website.

### TECHNICAL FIELD

The invention generally relates to computers and computer software, and in particular to methods, systems, and computer program products for allowing search criteria to be shared across multiple search spaces.

### BACKGROUND

Computer technology is increasingly used in the travel industry to manage, support, book, reserve, and process travel reservations as well as data associated therewith. For example, travel websites allow for a user, such as a traveler, to book various reservations such as airline tickets, train tickets, hotel reservations, or car rentals. In order to find the lowest price available for a particular travel product or service, a traveler usually compares the price offered for a particular travel product between various travel merchants before actually booking a reservation. In order to compare prices between various travel merchants, the traveler may need to search multiple travel websites.

A traveler usually enters parameters pertaining to a particular travel product or service numerous times into various websites when comparing prices between various travel merchants. Some of the various search parameters that are entered into a particular website in order to find an airline ticket include, for example, the departure date and a class of service, or, to find a hotel, a start date and a class of service. The class of service indicates the overall quality of a service and includes, for example, the number of stars for a hotel or the cabin type such as first class or economy for an airline flight. However, repeatedly entering travel parameters into multiple travel websites often becomes cumbersome for the traveler. Moreover, entering the information into each travel website is also time consuming.

Some advertising companies may monitor the traveler's activity on both general purpose as well as travel websites. The advertising company may then display a promotional advertisement for specific travel products based on the traveler's search activity. For example, a traveler may search for hotels in New York City. Accordingly, the advertising company then generates and displays a promotional advertisement for a product that is similar to the traveler's search criteria. In the present example, the advertising company may display a promotional advertisement for inexpensive or budget hotels in New York City. However, these advertisements are actually just general promotions based on just a few parameters of a user's search. In many cases, the advertisements may not accurately reflect the specific parameters of the traveler's search. For example, the traveler may not select the advertisement for budget hotels since he or she was actually searching for a luxury hotel in Manhattan. Furthermore, even if the traveler selects the advertisement, he or she will still need to enter the travel information into the promotional website in order to view refined offers. In another scenario in which multiple users share a single computer device, device-specific, user activity tracking may prove ineffective. Specifically, the advertisements presented to different users of the single computer device may not be relevant or of interest to any of the users.

### SUMMARY

In an embodiment of the invention, a system for processing search criteria across multiple search spaces is provided. The system includes one or more processors and a memory coupled to the processors. The memory stores data comprising program code that, when executed by the processors, causes the system to receive authentication information to grant a user access to a universal profile platform associated with the system. In response to receiving the authentication information, the system is caused to grant access to the universal profile platform. The universal profile platform provides access to a first search website and a second search website that are external to the system. The system is further caused to store, in a universal profile database, profile data that includes a plurality of first search criteria submitted by the user to the first search website. The first search criteria indicates at least one parameter of a first search performed by the first search website. The system is further caused to receive a first request from the second search website. The first request is for the first search criteria stored in the universal profile database. In response to receiving the first request from the second search website, the system is caused to retrieve the profile data from the universal profile database. Finally, the system is caused to direct the first search criteria of the profile data to the second search website. The second search website determines a plurality of second results in response to receiving the first search criteria.

In another embodiment of the invention, in response to receiving a second request from a third search website, the system is caused to retrieve the profile data from the universal profile database. The third search website is external to the system.

In yet another embodiment, in response to receiving the second request from the third search website, the system is caused to compare a first attribute associated with the first search criteria to a second attribute associated with a second search criteria. The system is also caused to select the second search criteria for provision to the third search website based on the comparison.

In one embodiment, the first attribute is a first timestamp indicative of when the first search criteria was submitted to the first search website and the second attribute is a second timestamp indicative of when the second search criteria was submitted to the second search website. The second timestamp is more recent than the first timestamp.

In another embodiment, the first attribute is a first frequency indicating a number of times the user has used the first search criteria and the second attribute is a second frequency indicating a number of time the user has used the second search criteria. The second frequency is greater than the first frequency.

In yet another embodiment, the system is further caused to determine that a travel product that matches parameters of the first search criteria has been booked. In response to determining that the travel product is booked, the system is caused to purge the first search criteria from the universal profile database.

In still another embodiment, the system is caused to determine that a current date is greater than a date provided by the user. The date provided by the user is an expiration date of the first search criteria. In response to determining that the current date is more recent than the date provided by the user, the system is caused to allow the first search criteria to expire.

In one embodiment, in response to the first request from the second search website being received, the system is caused to send a third request to the user to grant the second search website access to the profile data stored in the universal profile database. The system is caused to receive, from a device of the user, a second authorization to grant the second search website access to the profile data. The system is also caused to store the second authorization to grant the second search website access to the profile data.

In another embodiment, the first search website and the second search website are each associated with merchants that sell a same type of products or services.

In still another embodiment, the first search website is associated with a first merchant that offers a plurality of products or services, and the second search website is associated with a second merchant that offers only one of the plurality of products or services.

In one embodiment, a method for processing search criteria across multiple search spaces is provided. The method includes receiving, by a computer, authentication information to grant a user access to a universal profile platform associated with the system. In response to receiving the authentication information, the method includes granting, by the computer, access to the universal profile platform. The universal profile platform provides access to a first search website and a second search website that are external to the system. The method includes storing, in a universal profile database, profile data that includes a plurality of first search criteria submitted by the user to the first search website. The first search criteria indicates at least one parameter of a first search performed by the first search website. The method also includes receiving, by the computer, a first request from the second search website. The first request is for the first search criteria stored in the universal profile database. In response to receiving the first request from the second search website, the method further includes retrieving the profile data from the universal profile database. Finally, the method includes directing the first search criteria of the profile data to the second search website. The second search website determines a plurality of second results in response to receiving the first search criteria.

In another embodiment, a computer program product comprises a non-transitory computer-readable storage medium and program code stored on the non-transitory computer-readable storage medium that, when executed by one or more processors, causes the one or more processors to receive authentication information to grant a user access to a universal profile platform associated with the system. In response to receiving the authentication information, the system is caused to grant access to the universal profile platform. The universal profile platform provides access to a first search website and a second search website that are external to the system. The system is further caused to store, in a universal profile database, profile data that includes a plurality of first search criteria submitted by the user to the first search website. The first search criteria indicates at least one parameter of a first search performed by the first search website. The system is further caused to receive a first request from the second search website. The first request is for the first search criteria stored in the universal profile database. In response to receiving the first request from the second search website, the system is caused to retrieve the profile data from the universal profile database. Finally, the system is caused to direct the first search criteria of the profile data to the second search website. The second search website determines a plurality of second results in response to receiving the first search criteria.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment for accessing third party search websites using a universal profile.

FIG. 2 is a diagrammatic view of an exemplary computer system of FIG. 1.

FIG. 3 is a more detailed diagrammatic view of the operating environment of FIG. 1.

FIG. 4 is a process flow diagram illustrating an exemplary method for sharing search criteria across multiple search websites.

### DETAILED DESCRIPTION

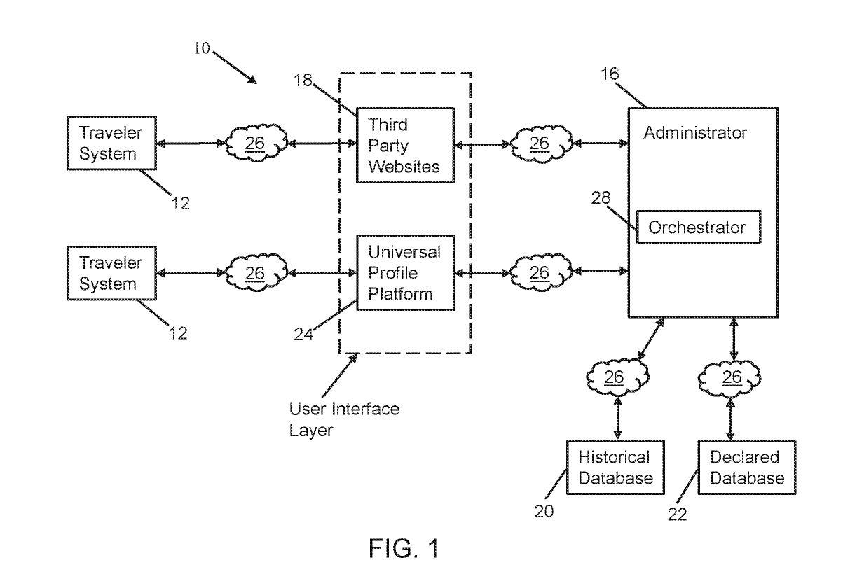

Referring now to FIG. 1, an operating environment 10 in accordance with an embodiment of the invention may include a traveler system 12 and an administrator 16. The administrator 16 acts as a system interface, and is in communication with one or more third party search websites 18. The administrator 16 is in communication with a historical database 20 and a declared database 22. The traveler system 12, the administrator 16, the third party websites 18, the historical database 20, and the declared database 22 may communicate with each other through a network 26. The network 26 may include one or more private or public networks (e.g., the Internet) that enable the exchange of data.

The traveler system 12 may comprise a desktop computer, laptop computer, tablet computer, smart phone, or any other suitable computing device. The traveler may use the traveler system 12 to search for and book travel services by accessing a reservation system, or any other suitable system though the network 26. The traveler system 12 may access a universal profile platform 24, which is operated by a specific reservation system.

The universal profile platform 24 allows for the traveler system 12 to gain access to the third party website 18 in order to search and book travel reservations. Specifically, the traveler may access the universal profile platform 24 using an authentication process such as entering a login identifier and/or password. In response to receiving the traveler's authentication information, the universal profile platform 24 allows the traveler to access the travel reservation search engine associated with the reservation system that operates the universal profile platform 24. Additionally, the traveler may also access the third party websites 18 that are external to the reservation system through the universal profile platform 24. As such, the third party websites 18 and the universal profile platform 24 define a user interface level, as generally indicted in FIG. 1.

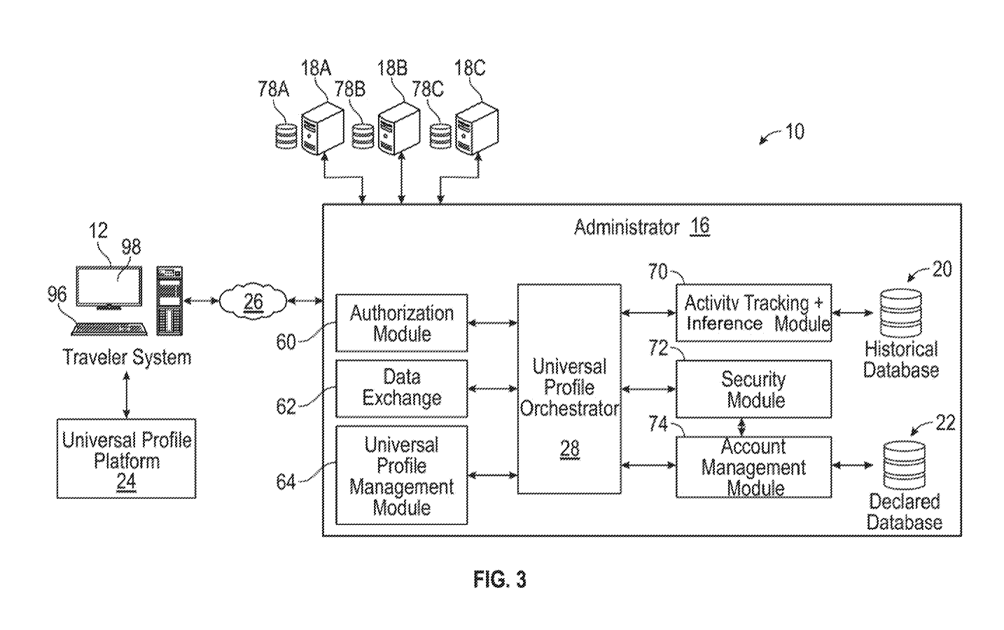

The universal profile platform 24 also allows for traveler to access profile data stored in a universal profile database. The historical database 20 and the declared database 22 are part of the universal profile database. The databases 20, 22 store profile data as well as traveler information required to book a specific travel arrangement. As explained in greater detail below, the administrator 16 includes a universal profile orchestrator 28 that aggregates the historical and declared data stored in the historical database 20 and the declared database 22. The universal profile orchestrator 28 also collects inferred information from a activity tracking and inference module 70 contained in the administrator 16 (shown in FIG. 3), which is explained below. Thus, the universal profile database includes the databases 20, 22 as well as activity tracking and inference module 70.

In one non-limiting embodiment, the universal profile orchestrator 28 collects identifying characteristics such as, but not limited to, the traveler's name, contact details, and regulatory information from the declared database 22. The universal profile orchestrator 28 may also collect the specific search criteria related to the traveler's search such as, but not limited to, a start date, an end date, whether the dates are flexible, class of services, and sort criteria. The start date may be the departure date for an airline flight, or the starting date of a hotel stay. The end date may be the arrival date for an airline flight, or the end of a hotel stay. The class of services indicates the overall quality of service and includes, for example, the number of stars for a hotel or the cabin type for a flight. Sort criteria indicates whether the user explicitly requested a sort of the search results based on factor such as, for example, price or duration. The search criteria may include other characteristics as well such as, for example, if the traveler prefers a non-stop flight, specific dietary restrictions or preferences such as kosher or vegetarian meals, and gluten free meals. In one approach, the search criteria may also include a user's preference for a particular airline.

In one embodiment, the universal profile data is associated with a specific travel entity or merchant. The merchant may be, but is not limited to, an online travel agent, a physical travel agent, or a orchestrator website that compiles results from multiple booking engines and travel websites. For example, the aggregator may be a hotel aggregation website or an airline aggregation website.

The administrator 16 is in communication with the traveler system 12, the third party websites 18, and the administrator 16. As explained in greater detail below, the administrator 16 may be used to ensure that a traveler may be able to login to various third party travel websites using his or her credentials associated with data stored the universal profile database. The administrator 16 is in communication with the administrator 16, and may be used to provide security capabilities such as, for example, login functionalities, to the universal profile.

The third party websites 18 may also be referred to as search spaces. Each third party website 18 may be accessed through the universal profile platform 24 by the traveler system 12 in order to search for and/or book travel reservations. In one embodiment, the third party website 18 is a travel website dedicated to booking travel accommodations. For example, in one embodiment the travel website may be a hotel or an airline's website. In another embodiment, the third party website 18 is a general website that allows for a user to book travel reservations. However, the general website is not dedicated to booking travel accommodations, and may also provide other services as well. For example, a search engine may also provide a user with the ability to search for and book travel reservations online. In still another embodiment, the third party website 18 may represent a physical location of a travel agency (i.e., a brick and mortar building).

In one embodiment, the websites 18 may all be of the same type. That is, the merchants associated with each website 18 each sell the same type of travel products or services. For example, each website 18 may sell airline tickets. In another embodiment, one of the third party websites 18 offers multiple travel products and services such as, for example, airline tickets, car rentals, hotel reservations, and restaurants. However, one of the other third party websites 18 may only offer a single type of product or service, such as airline tickets. If this is the case, then the website 18 that only offers a single travel service or product sends a request to the administrator 16. The request is for data only pertaining to the specific product or service offered by the merchant of the website. However, in another approach the merchant may offer multiple products and services (e.g., airline flights and hotel reservations). In this example, the website 18 may send a request for data to the administrator 16 for only a single product or service. The decision as to which product or service that is selected may be based on business rules. Alternatively, the website 18 sends a request to the traveler to select a particular product or service that he or she is most interested in purchasing. In still another approach, the website 18 may expect the reservation system that operates the universal profile platform 24 to select a particular product or service.

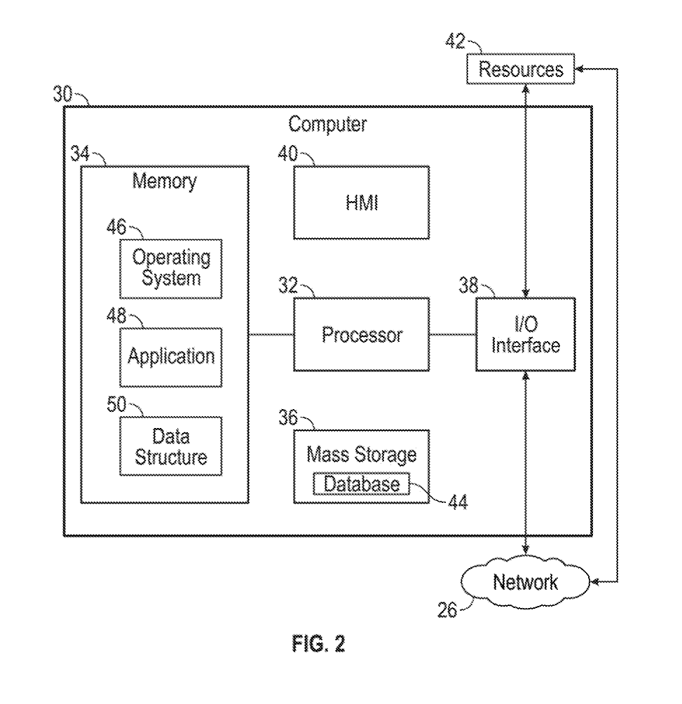

Referring now to FIG. 2, the traveler system 12, the administrator 16, and the third party websites 18 of the operating environment 10 may be implemented on one or more computer devices or systems, such as exemplary computer system 30. The computer system 30 may include a processor 32, a memory 34, a mass storage memory device 36, an input/output (I/O) interface 38, and a Human Machine Interface (HMI) 40. The computer system 30 may also be operatively coupled to one or more external resources 42 via the network 26 or I/O interface 38. External resources may include, but are not limited to, servers, databases, mass storage devices, peripheral devices, cloud-based network services, or any other suitable computer resource that may be used by the computer system 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, volatile or non-volatile solid state device, or any other device capable of storing information.

The processor 32 may operate under the control of an operating system 46 that resides in memory 34. The operating system 46 may manage computer resources so that computer program code embodied as one or more computer software applications, such as an application 48 residing in memory 34, may have instructions executed by the processor 32. In an alternative embodiment, the processor 32 may execute the application 48 directly, in which case the operating system 46 may be omitted. One or more data structures 50 may also reside in memory 34, and may be used by the processor 32, operating system 46, or application 48 to store or manipulate data.

The I/O interface 38 may provide a machine interface that operatively couples the processor 32 to other devices and systems, such as the network 26 or external resource 42. The application 48 may thereby work cooperatively with the network 26 or external resource 42 by communicating via the I/O interface 38 to provide the various features, functions, applications, processes, or modules comprising embodiments of the invention. The application 48 may also have program code that is executed by one or more external resources 42, or otherwise rely on functions or signals provided by other system or network components external to the computer system 30. Indeed, given the nearly endless hardware and software configurations possible, persons having ordinary skill in the art will understand that embodiments of the invention may include applications that are located externally to the computer system 30, distributed among multiple computers or other external resources 42, or provided by computing resources (hardware and software) that are provided as a service over the network 26, such as a cloud computing service.

The HMI 40 may be operatively coupled to the processor 32 of computer system 30 in a known manner to allow a user to interact directly with the computer system 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 44 may reside on the mass storage memory device 36, and may be used to collect and organize data used by the various systems and modules described herein. The database 44 may include data and supporting data structures that store and organize the data. In particular, the database 44 may be arranged with any database organization or structure including, but not limited to, a relational database, a hierarchical database, a network database, or combinations thereof. A database management system in the form of a computer software application executing as instructions on the processor 32 may be used to access the information or data stored in records of the database 44 in response to a query, where a query may be dynamically determined and executed by the operating system 46, other applications 48, or one or more modules.

Turning now to FIG. 3, in an exemplary embodiment of the disclosure the administrator 16 may include an authorization module 60, a data exchange module 62, and a universal profile management module 64. The administrator 16 also includes the activity tracking and inference module 70, a security module 72, and an account management module 74. As seen in FIG. 3, the authorization module 60, the data exchange module 62, and the account management module 74 are each in communication with the universal profile orchestrator 28. The universal profile orchestrator 28 is in communication with the activity tracking and inference module 70, the security module 72, and the account management module 74. The activity tracking and inference module 70 is in communication with the historical database 20, the security module 72 is in communication with the account management module 74, and the account management module 74 is in communication with the declared database 22. FIG. 3 also illustrates a respective database 78 associated with each website 18. Each database 78 stores a dataset associated with a corresponding website 18.

The modules 60, 62, 64, 70, 72, 74 are shown as distinct components, which may indicate the use of modular programming techniques. However, the software design may decrease the extent to which the modules 60, 62 and the sub-modules 60, 62, 64, 70, 72, 74 are distinct by combining at least some program functions of multiple modules into a single module. Moreover, those of ordinary skill in the art will readily understand that the functions attributed to the modules 60, 62, 64, 70, 72, 74 may be distributed in other ways, or on other systems than those depicted. Thus, embodiments of the invention are not limited to the specific arrangement of systems or modules shown in FIG. 3.

Continuing to refer to FIG. 3, the authorization module 60 of the administrator 16 allows for a traveler to sign in to the third party websites 18 based on data stored in the universal profile database. The data exchange module 62 of the administrator 16 creates an application program interface (API) that allows for a merchant to send data related to the traveler to the universal profile database. The API also allows for the universal profile database to send data to the merchant. The universal profile management module 64 of the administrator 16 allows for the traveler to access and modify his or her own unique universal profile stored in the universal profile database. It is to be appreciated that the traveler may also maintain the universal profile through an application provided by the merchant.

The activity tracking and inference module 70 of the administrator 16 analyzes the information saved in the historical database 20, and creates inferred data based on the analysis. Historical information may indicate various patterns in a traveler's search habits. Some examples of historical information include, but are not limited to, search occurrence, date of the search, and the latest search. Search occurrences denote the number of times the traveler has performed a particular search, or an equivalent search. The date of the search denotes the date of the search, or an equivalent search, has been performed for the first time. The latest search denotes the date where the search, or an equivalent search, has been performed most recently.

Equivalent searches may occur when the traveler conducts searches that different from a strictly literal of view, but the products or services request may still be substantially the same. For example, a traveler may search for flights between identical cities, but from different airports. Specifically, the traveler may search for flights between JFK Airport (in New York City) and O'Hare Airport (in Chicago). An equivalent search would be considered a search for flights between LaGuardia Airport (also in New York City) and Midway Airport (also in Chicago).

The activity tracking and inference module 70 of the administrator 16 may analyze the historical data from the database 20 in order to determine inferred data. For example, a preferred cabin or class of service may be deduced by the activity tracking and inference module 70 based on the traveler's search history. In another embodiment, the activity tracking and inference module 70 may deduce a traveler's most important travel preference based on a traveler's sort history. Some examples of travel preferences include ticket price, class, or trip duration.

Continuing to refer to FIG. 3, the security module 72 of the administrator 16 provides security capabilities such as, for example, login functionalities and access to the universal profile database. Finally, the account management module 74 of the administrator 16 manages the information stored in the declared database 22. The declared information stored in the declared database includes characteristics that the traveler has specified about himself or herself, and may include data such as, but not limited to, a traveler's name, contact details, and regulatory information.

In one embodiment, a traveler may initiate a travel search using multiple search spaces or websites in order to locate travel reservations. Specifically, the traveler may access the universal profile platform 24 using an authentication process such as, for example, by entering a login identifier and/or password. In response to receiving the traveler's authentication information, the universal profile platform 24 grants the traveler permission to access a first search website. In one exemplary embodiment, the first search website may be the universal profile platform 24. Alternatively, the first search website may be one of the third party websites 18.

In one exemplary embodiment to grant access to the universal profile platform 24, a tracking cookie is created in response to the traveler's credentials being approved. The tracking cookie allows for the traveler to gain access to the first search website. In another embodiment, the traveler first accesses the first search website, which is connected to the universal profile platform 24. The traveler provides authentication data through the first search website. The authorization module 60 verifies the data. In response to the data being verified, a tracking cookie is created, which allows for the traveler to access the universal profile platform 24 as well as other associated travel websites that have subscribed to the universal profile platform 24. In still another embodiment, the universal profile platform 24 may include a search space. The traveler may be granted access to the universal profile platform 24, and then gains access to any of the travel websites that have subscribed to the universal profile platform 24.

Once permission to access the first search website is granted, the account management module 74 of the administrator 16 sends data stored in the declared database 22 to the first search website via the universal profile orchestrator. Specifically, declared information such as the traveler's name, contact details, and regulatory information stored in the declared database may be sent to the first search website. The first search website may be populated with the traveler's information. Therefore, the traveler does not need to fill in this information manually.

The traveler may initiate a search for a travel product by submitting a plurality of first search criteria to the first search website. Specifically, the traveler may use the keyboard 96 or any other input device of the traveler system 12 in order to submit the first search criteria. The first search criteria indicates at least one parameter for a search performed by the first search website. For example, a traveler may submit search criteria indicating a first class airline ticket to New York City during the first week of May to be searched by the first search website.

In one embodiment, the first search criteria may be set to expire or be purged based on specific conditions. In one example, once a trip that matches parameters of the first search criteria has been booked, then the first search criteria is purged from the universal profile database. In another embodiment, the traveler provides a date that indicates an expiration date of the first search criteria. The first search criteria is allowed to expire in response to the current date being greater or more recent than the date provided by the traveler. In still another embodiment, the first search criteria may be purged manually by the traveler as well.

In response to receiving the first search criteria, the first search website initiates a search of a first dataset that satisfies the first search criteria. For example, the website 18A may initiate a search of the associated dataset stored in the database 78A. The first search website locates a plurality of search results that match the first search criteria, and then transmits the first search results over the network 26 to the travel system 12. The first search results are shown upon a display 98 of the travel system 12 for consideration by the traveler.

Profile data including the first search criteria may then be stored within the historical database 20 and the declared database 22. In the present example, the search occurrence is one, the date of the search is April 10th, and the latest search was performed on April 10th as well. The data indicating the travel destination, which is New York City, the start date, which is the first week of May, and the class of service, which is first class, are all stored within the declared database 22. In one embodiment, the profile data stored within the declared database 22 includes sort criteria, which indicates whether traveler user explicitly requested a sort of the search results based on price or duration. Specifically, the sort criteria is submitted by the traveler to the first search website, and is used to specific the first search results that are shown upon the display of the travel system 12.

The traveler may then decide to search another travel website for a lower price or for other available travel options. Accordingly, the traveler may then access a second search website through the universal profile platform 24. The second search website identifies and grants the traveler permission to access and search the site based on receiving authentication information. In one embodiment, the authentication information is a login identifier and/or password entered by the traveler to gain access to the second search website. Alternatively, in another embodiment the second search website may grant the traveler permission to access and search the website based on a tracking cookie. Tracking cookies are a specific type of cookie that may be distributed, shared, and read across two or more unrelated websites to provide customized data.

The second search website then sends a request to the administrator 16 to retrieve the first search criteria stored in the universal profile database. In response to receiving the request from the second search website, the authorization module 60 of the administrator 16 sends a request to the traveler system 12. The request asks the traveler to grant the second search website access to the universal profile database. The profile data containing the first search criteria is stored in the universal profile database. In response to receiving the request, the traveler may grant access to the universal profile database using the keyboard 96 or any other input device of the traveler system 12. In response to receiving the authorization from the traveler system 12, the security module 72 of the administrator 16 grants the second search website access to the profile data stored in the universal profile database. The authorization is also stored in the declared database 22.

The second search website is populated with the traveler's information and the first search criteria from the universal profile database. Therefore, the traveler does not need to fill in this information manually. In response to receiving the first search criteria of the profile data, the second search website initiates a second search of a second dataset associated with the second search website based on the first search criteria. The second search website then determines a plurality of second search results. For example, in one embodiment the website 18B may represent the second search website, where the website 18B initiates a second search of the dataset stored in the database 78B.

In one embodiment, the profile data includes the sort criteria submitted by the traveler to the first search website. If the profile data includes the sort criteria, the sort criteria is also submitted to the second search website. The second search website may then display second search results that are in accordance with the sort criteria upon the display 98 of the traveler system 12. In an embodiment, the user may decide to modify one or more parameters of the first search criteria when searching the second search website. The modified set of first search criteria is referred to as a second search criteria, since the parameters of the first search criteria have changed. The second search criteria may then be stored as part of the profile data within the universal profile database.

The traveler may then decide to search yet another travel website. Therefore, the traveler may access a third travel website through the universal profile platform 24. Similar to the second search website, the third search website may also grant the traveler permission to access and search the site based on receiving authentication information such as a login identifier and/or password entered by the traveler, or a tracking cookie. In response to the traveler system 12 accessing the third search website, the universal profile orchestrator 28 of the administrator 16 retrieves and sends the profile data to the third website. The profile data is directed to the third search website. In response to receiving the profile data, the third search website determines a plurality of third search results by initiating a third search of a third dataset associated with the third website based on the second search criteria. For example, the website 18C may represent the third website, where the website 18C initiates a search of the dataset stored in the database 78C.

In one embodiment, in response to receiving the profile data, the third website may compare attributes that are submitted by the traveler between the various websites. For example, in one embodiment the attribute may comprise a timestamp indicative of when a specific search criteria was submitted to a particular website 18. In yet another embodiment, the attribute may include a frequency associated with a specific search criteria. The frequency represents how many times the traveler has used a specific search criteria.

In the embodiment as described, the data exchange module 62 of the administrator 16 may compare a first attribute associated with the first search criteria to a second search criteria associated with the second search criteria. Based on the comparison, either the first search criteria or the second search criteria is selected for provision to the third search website. For example, if the attribute is a timestamp, then the first timestamp indicates when the first search criteria was submitted to the first search website and the second timestamp indicates when the second search criteria is submitted to the second search website. The data exchange module 62 of the administrator 16 determines that the second timestamp is more recent than the first timestamp, and therefore selects the second search criteria. In another embodiment, the first attribute is a first frequency associated with how many times the traveler has used the first search criteria and a second attribute is a second frequency associated with how many times the traveler has used the second search criteria. The data exchange module 62 of the administrator 16 determines that the first frequency is greater than the second frequency. Thus, the first search criteria is selected for provision to the third website.

Referring generally to FIGS. 1-3, the described system provides a unique improvement in computer-related technology by allowing computer performance of a function that was not previously performed by a computer. For example, the described system allows for a user to search multiple websites by relying upon profile data stored in the universal profile database. In particular, the described system shares the profile data stored in the universal profile database that was previously entered by the traveler with a third party website accessed by a traveler. In contrast, the conventional approach to search for data required a traveler to enter search parameters pertaining to a particular travel product or service over and over again when visiting different websites. Moreover, it is to be appreciated that the specific rules followed by the described system have not previously been used by travelers or reservation agents to search multiple websites. Some examples of these rules include, but are not limited to, storing profile data in the universal profile database, and retrieving the profile data from the universal profile database in response to receiving the request from the second search website.

Furthermore, the described system follows a non-conventional and non-generic approach to search multiple websites. Indeed, the combination of storing profile data in the universal profile database and then retrieving the profile data from the universal profile database in response to receiving the request from the second search website is a non-conventional approach to prepopulate the second search website when the traveler is searching multiple websites. Finally, it should also be appreciated that the data stored in the universal profile database uniquely represents a traveler or user, and is independent from any type of travel merchant such as a hotel, airline, or car rental service.

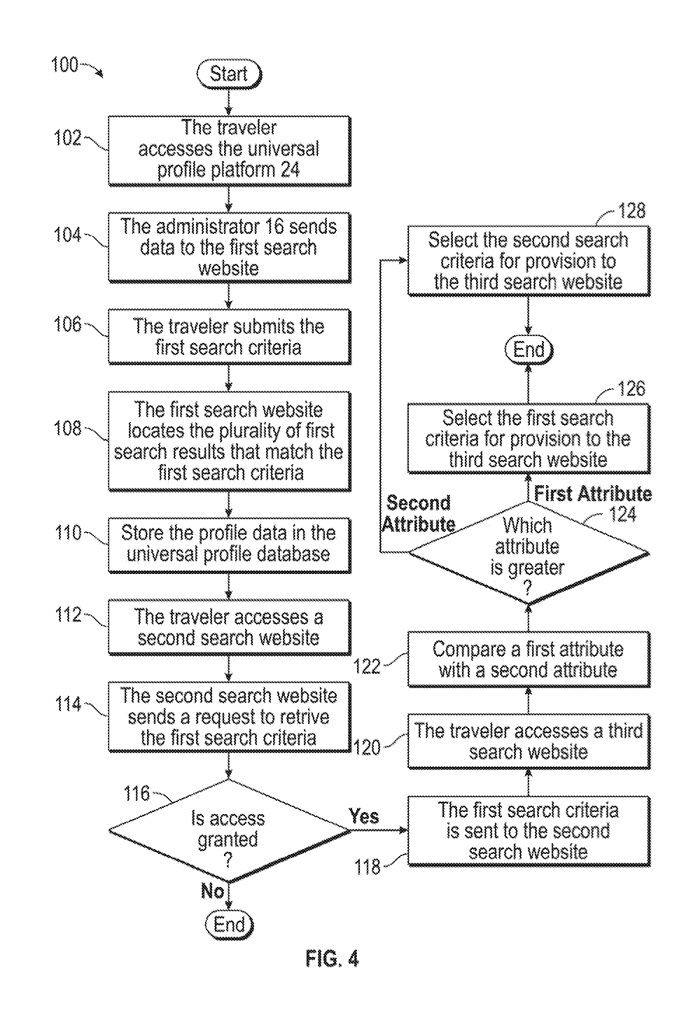

Turning now to FIG. 4, a flowchart that depicts a process 100 that may be performed by the administrator 16 and the third party websites 18 that enables a user to search multiple search websites in order to book travel reservations is shown.

Referring to both FIGS. 3 and 4, process 100 may begin at block 102, where the traveler initiates a search by accessing the universal profile platform 24. Specifically, the traveler accesses the universal profile platform 24 by using a login identifier and/or password. In response to receiving the authentication information, the universal profile platform 24 grants the traveler access to the first search website. Process 100 may then proceed to block 104.

In block 104, the account management module 74 of the administrator 16 sends data stored in the database to the first search website. The first search website may then be populated with the traveler's information, such as the traveler's name, contact details, and regulatory information. Process 100 may then proceed to block 106.

In block 106, the traveler initiates the first search for a travel product by submitting the plurality of first search criteria to the first search website using the keyboard 96 or other input device of the traveler system 12. In response to receiving the first search criteria, the first search website initiates a search of the first dataset that satisfies the first search criteria. Process 100 may then proceed to block 108.

In block 108, the first search website locates the plurality of first search results that match the first search criteria, and transmits the results over the network and to the travel system 12. The results are shown upon the display of the traveler system 12. Process 100 may then proceed to block 110.

In block 110, profile data including the first search criteria is stored within the universal profile database. Process 100 may then proceed to block 112.

In block 112, the traveler accesses the second search website using the universal profile platform 24. The second search website identifies the user and grants the traveler permission to access and search based on receiving authentication information such as, for example, a login identifier and/or password, or by tracking cookies. Process 100 may then proceed to block 114.

In block 114, the second search website sends a request to retrieve the administrator 16 the first search criteria stored in the universal profile database. Process 100 may then proceed to block 116.

In block 116, in response to receiving the request from the second search website, the traveler system 12 send a query to the traveler asking if the second search website may have access to the profile data containing the first search criteria. If the user grants access, then process may proceed to block 120. However, if no access is granted, then process 100 may terminate.

In block 118, the first search criteria contained in the universal profile database is directed to the second search website. In response to receiving the first search criteria, the second search website determines a plurality of second results. Process 100 may then proceed to block 120.

In block 120, the traveler may access the third website using the universal profile platform 24. Similar to the second search website, the third search website may grant the traveler access based on a login and/or password or by tracking cookies. Process 100 may then proceed to block 122.

In block 122, in response to receiving the profile data, the third website may compare attributes that are submitted by the traveler between the various websites. Specifically, the data exchange module 62 of the administrator 16 may compare the first attribute associated with the first search criteria to the second search criteria associated with the second search criteria. As described above, the attribute may be a timestamp or a frequency associated with how many times the traveler has used the either the first search criteria or the second search criteria. Process 100 may then proceed to block 124.

In block 124, if the first attribute is greater than the second attribute, then process 100 may proceed to block 126. In block 126, the first search criteria is selected for provision to the third search website. Process 100 may then terminate. However, if the second attribute is greater than the first attribute, then process 100 may proceed to block 128. In block 128, the second search criteria is selected for provision to the third search website. Process 100 may then terminate.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow charts, sequence diagrams, and/or block diagrams.

In certain alternative embodiments, the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for processing search criteria across multiple search spaces, the system comprising:
one or more processors; and
a memory coupled to the one or more processors, the memory storing data comprising program code that, when executed by the one or more processors, causes the system to:
receive authentication information to grant a user access to a universal profile platform associated with the system;
in response to receiving the authentication information, grant access to the universal profile platform, wherein the universal profile platform provides access to a first search website and a second search website that are external to the system;
store, in a universal profile database, profile data that includes a plurality of first search criteria submitted by the user to the first search website, wherein first search criteria indicates at least one parameter of a first search performed by the first search web site;
receive a first request from the second search website, wherein the first request is for the first search criteria stored in the universal profile database;
in response to receiving the first request from the second search website, retrieve the profile data from the universal profile database; and
direct the first search criteria of the profile data to the second search website, wherein the second search website determines a plurality of second results in response to receiving the first search criteria.

2. The system of claim 1 wherein the program code, when executed by the one or more processors, further causes the system to:
in response to receiving a second request from a third search website, retrieve the profile data from the universal profile database, wherein the third search website is external to the system.

3. The system of claim 2 wherein the program code, when executed by the one or more processors, further causes the system to:
in response to receiving the second request from the third search website, compare a first attribute associated with the first search criteria to a second attribute associated with a second search criteria; and
select the second search criteria for provision to the third search website based on the comparison.

4. The system of claim 3 wherein the first attribute is a first timestamp indicative of when the first search criteria was submitted to the first search website, the second attribute is a second timestamp indicative of when the second search criteria was submitted to the second search website, and the second timestamp is more recent than the first timestamp.

5. The system of claim 3 wherein the first attribute is a first frequency indicating a number of times the user has used the first search criteria, the second attribute is a second frequency indicating a number of times the user has used the second search criteria, and the second frequency is greater than the first frequency.

6. The system of claim 1, wherein the instructions upon execution further cause the system to:
determine that a travel product that matches parameters of the first search criteria has been booked; and
in response to determining that the travel product is booked, purge the first search criteria from the universal profile database.

7. The system of claim 1, wherein the instructions upon execution further cause the system to:
determine that a current date is more recent a date provided by the user, wherein the date provided by the user is an expiration date of the first search criteria; and
in response to determining that the current date is more recent than the date provided by the user, allow the first search criteria to expire.

8. The system of claim 1 wherein the instructions upon execution further cause the system to:
in response to the first request from the second search website being received, send a third request to the user to grant the second search website access to the profile data stored in the universal profile database;
receive, from a device of the user, a second authorization to grant the second search website access to the profile data; and
store the second authorization to grant the second search website access to the profile data.

9. The system of claim 1 wherein the first search website and the second search website are each associated with merchants that sell a same type of products or services.

10. The system of claim 1 wherein the first search website is associated with a first merchant that offers a plurality of products or services, and the second search website is associated with a second merchant that offers only one of the plurality of products or services.

11. A method of processing search criteria across multiple search spaces, the method comprising:
receiving, by a computer, authentication information to grant a user access to a universal profile platform associated with the system;
in response to receiving the authentication information, granting, by the computer, access to the universal profile platform, wherein the universal profile platform provides access to a first search website and a second search website that are external to the system;
storing, in a universal profile database, profile data that includes a plurality of first search criteria submitted by the user to the first search website, wherein first search criteria indicates at least one parameter of a first search performed by the first search website;
receiving, by the computer, a first request from the second search website, wherein the first request is for the first search criteria stored in the universal profile database;
in response to receiving the first request from the second search website, retrieving the profile data from the universal profile database; and
directing the first search criteria of the profile data to the second search website, wherein the second search website determines a plurality of second results in response to receiving the first search criteria.

12. The method of claim 11 further comprising:
in response to receiving a second request from a third search website, retrieving the profile data from the universal profile database, wherein the third search website is external to the system.

13. The method of claim 12 further comprising:
in response to receiving the second request from the third search website, comparing a first attribute associated with the first search criteria to a second attribute associated with a second search criteria; and
selecting the second search criteria for provision to the third search website based on the comparison.

14. The method of claim 13 wherein the first attribute is a first timestamp indicative of when the first search criteria was submitted to the first search website, the second attribute is a second timestamp indicative of when the second search criteria was submitted to the second search website, and the second timestamp is more recent than the first timestamp.

15. The method of claim 13 wherein the first attribute is a first frequency indicating a number of times the user has used the first search criteria, the second attribute is a second frequency indicating a number of times the user has used the second search criteria, and the second frequency is greater than the first frequency.

16. The method of claim 11 further comprising:
determining that a travel product that matches parameters of the first search criteria has been booked; and
in response to determining that the travel product is booked, purging the first search criteria from the universal profile database.

17. The method of claim 11 further comprising:
determining that a current date is more recent than a date provided by the user, wherein the date provided by the user is an expiration date of the first search criteria; and
in response to determining that the current date is more recent than the date provided by the user, allowing the first search criteria to expire.

18. The method of claim 11 further comprising:
in response to the first request from the second search website being received, sending a third request to the user to grant the second search website access to the profile data stored in the universal profile database;
receiving, from a device of the user, a second authorization to grant the second search website access to the profile data; and
storing the second authorization to grant the second search website access to the profile data.

19. The method of claim 11 wherein the first search website and the second search website are each associated with merchants that sell a same type of products or services.

20. The method of claim 11 wherein the first search website is associated with a first merchant that offers a plurality of products or services, and the second search web site is associated with a second merchant that offers only one of the plurality of products or services.

21. A computer program product for processing search criteria across multiple search spaces, the computer program product comprising:
a non-transitory computer-readable storage medium; and
program code stored on the non-transitory computer-readable storage medium that, when executed by one or more processors, causes the one or more processors to:
receive authentication information to grant a user access to a universal profile platform associated with the system;
in response to receiving the authentication information, grant access to the universal profile platform, wherein the universal profile platform provides access to a first search website and a second search website that are external to the system;
store, in a universal profile database, profile data that includes a plurality of first search criteria submitted by the user to the first search website, wherein first search criteria indicates at least one parameter of a first search performed by the first search web site;
receive a first request from the second search website, wherein the first request is for the first search criteria stored in the universal profile database;
in response to receiving the first request from the second search website, retrieve the profile data from the universal profile database; and
direct the first search criteria of the profile data to the second search website, wherein the second search website determines a plurality of second results in response to receiving the first search criteria.
